(19) United States
(12) Patent Application Publication
(10) Pub. No.: US 2024/0349347 A1
(43) Pub. Date: Oct. 17, 2024

(54) METHODS AND APPARATUSES FOR RANDOM ACCESS PROCEDURE

(71) Applicant: Lenovo (Beijing) Limited, Beijing (CN)

(72) Inventors: Yuantao Zhang, Beijing (CN); Hongmei Liu, Beijing (CN); Zhi Yan, Beijing (CN); Yingying Li, Beijing (CN); Jie Shi, Beijing (CN); Haiming Wang, Beijing (CN)

(73) Assignee: Lenovo (Beijing) Limited, Beijing (CN)

(21) Appl. No.: 18/294,260

(22) PCT Filed: Aug. 4, 2021
(86) PCT No.: PCT/CN2021/110552

§ 371 Date: Feb. 1, 2024

(51) Int. Cl. H04W 74/0833; H04W 74/00

(52) U.S. Cl. CPC H04W 74/0833; H04W 74/002

(57) ABSTRACT

Methods and apparatuses for random access procedure. A method performed by a user equipment (UE), including: receiving, from a base station (BS), multiple random access (RA) channel (RACH) configurations including a non-feature-related RACH configuration indicating a first subset of preambles in each RA occasion (RO) of a set of ROs configured for a contention-based (CB) RA procedure, and at least one feature-related RACH configuration associated with a first number of features, wherein each feature-related RACH configuration indicates a subset of preambles in each RO of the set of ROs for a feature; and determining a set of preambles for the UE to perform an RA procedure in an RO based on the first subset of preambles and a second subset of preambles that are determined from the at least one feature-related RACH configuration for the first number of features.

### TECHNICAL FIELD

The present disclosure relates to wireless communication technology, and especially to methods and apparatuses for random access procedure.

### BACKGROUND OF THE INVENTION

In 5G new radio (NR), a base station (BS) may need to identify a user equipment (UE) with one or more features during a random access (RA) procedure (e.g., an initial access procedure). To achieve this, the BS may utilize RA channel (RACH) partitioning for the features. RACH partitioning can be achieved by partitioning RA occasions (ROs) (i.e., mapping different ROs to different features) and/or by partitioning preambles associated with an RO (i.e., mapping different preambles to different features).

To reduce overhead for RACH configurations, it is desired to share ROs as much as possible between the UEs with the features and the UEs without the features, while guaranteeing the RACH performance for all the UEs.

### SUMMARY

Some embodiments of the present disclosure provide a method performed by a UE, which includes: receiving, from a BS, multiple RACH configurations including a non-feature-related RACH configuration indicating a first subset of preambles in each RO of a set of ROs configured for a contention-based (CB) RA procedure, and at least one feature-related RACH configuration associated with a first number of features, wherein each feature-related RACH configuration indicates a subset of preambles in each RO of the set of ROs for a feature; and determining a set of preambles for the UE to perform an RA procedure in an RO based on the first subset of preambles and a second subset of preambles that are determined from the at least one feature-related RACH configuration for the first number of features.

In an embodiment of the present disclosure, the first number of features include at least one of: reduced capability, coverage enhancement, small data transmission, and radio access network (RAN) slicing.

In an embodiment of the present disclosure, the set of preambles includes the first subset of preambles and the second subset of preambles, and the second subset of preambles are configured by the BS.

In an embodiment of the present disclosure, the set of preambles includes the first subset of preambles and the second subset of preambles, and the second subset of preambles includes the preambles that are configured for each of a second number of features among the first number of features that are not associated with the RO.

In an embodiment of the present disclosure, an order of each feature in the first number of features is preconfigured or indicated by the at least one feature-related RACH configuration, based on which the preambles for each feature are determined.

In an embodiment of the present disclosure, the preambles for each of a third number of features among the first number of features that are associated with the RO include a number of first sub-subsets, each first sub-subset corresponds to a feature in the third number of features, the preambles that are configured for each of the second number of features include a number of second sub-subsets, each second sub-subset corresponds to a feature in the second number of features, an order of each first sub-subset in the number of first sub-subsets is determined according to the relative order of feature(s) corresponding to the number of first sub-subsets, and an order of each second sub-subset in the number of second sub-subsets is determined according to the relative order of feature(s) corresponding to the number of second sub-subsets.

In an embodiment of the present disclosure, an order of each sub-subset in the number of first sub-subsets and the number of second sub-subsets is determined according to the order of a feature corresponding to the sub-subset.

In an embodiment of the present disclosure, each first sub-subset has an order lower than that of any second sub-subset.

In an embodiment of the present disclosure, each second sub-subset has an order lower than that of any first sub-subset.

In an embodiment of the present disclosure, the first number of features include a joint feature relating to at least a first independent feature and a second independent feature, and the at least one feature-related RACH configuration indicates at least a second number of preambles corresponding to the first independent feature and a third number of preambles corresponding to the second independent feature.

In an embodiment of the present disclosure, the at least one feature-related RACH configuration further indicates a fourth number of preambles corresponding to the joint feature, and the joint feature is configured with the fourth number of preambles including at least a first part of preambles from the second number of preambles and a second part of preambles from the third number of preambles.

In an embodiment of the present disclosure, the second number of preambles or the third number of preambles are configured for the joint feature when no RACH configuration indicates a number of preambles corresponding to the joint feature.

Some other embodiments of the present disclosure provide a method performed by a BS, which includes: transmitting, to a UE, multiple RACH configurations including a non-feature-related RACH configuration indicating a first subset of preambles in each RO of a set of ROs configured for a CB RA procedure, and at least one feature-related RACH configuration associated with a first number of features, wherein each feature-related RACH configuration indicates a subset of preambles in each RO of the set of ROs for a feature; and determining a set of preambles for the UE to perform an RA procedure in an RO based on the first subset of preambles and a second subset of preambles that are determined from the at least one feature-related RACH configuration for the first number of features.

In an embodiment of the present disclosure, the first number of features include at least one of: reduced capability, coverage enhancement, small data transmission, and RAN slicing.

In an embodiment of the present disclosure, the set of preambles includes the first subset of preambles and the second subset of preambles, and the second subset of preambles are configured by the BS.

In an embodiment of the present disclosure, the set of preambles includes the first subset of preambles and the second subset of preambles, and the second subset of preambles includes the preambles that are configured for each of a second number of features among the first number of features that are not associated with the RO.

In an embodiment of the present disclosure, an order of each feature in the first number of features is preconfigured or indicated by the at least one feature-related RACH configuration, based on which the preambles for each feature are determined.

In an embodiment of the present disclosure, the preambles for each of a third number of features among the first number of features that are associated with the RO include a number of first sub-subsets, each first sub-subset corresponds to a feature in the third number of features, the preambles that are configured for each of the second number of features includes a number of second sub-subsets, each second sub-subset corresponds to a feature in the second number of features, an order of each first sub-subset in the number of first sub-subsets is determined according to the relative order of feature(s) corresponding to the number of first sub-subsets, and an order of each second sub-subset in the number of second sub-subsets is determined according to the relative order of feature(s) corresponding to the number of second sub-subsets.

In an embodiment of the present disclosure, an order of each sub-subset in the number of first sub-subsets and the number of second sub-subsets is determined according to the order of a feature corresponding to the sub-subset.

In an embodiment of the present disclosure, each first sub-subset has an order lower than that of any second sub-subset.

In an embodiment of the present disclosure, each second sub-subset has an order lower than that of any first sub-subset.

In an embodiment of the present disclosure, the first number of features include a joint feature relating to at least a first independent feature and a second independent feature, and the at least one feature-related RACH configuration indicates at least a second number of preambles corresponding to the first independent feature and a third number of preambles corresponding to the second independent feature.

In an embodiment of the present disclosure, the at least one feature-related RACH configuration further indicates a fourth number of preambles corresponding to the joint feature, and the joint feature is configured with the fourth number of preambles including at least a first part of preambles from the second number of preambles and a second part of preambles from the third number of preambles.

In an embodiment of the present disclosure, the second number of preambles or the third number of preambles are configured for the joint feature when no RACH configuration indicates a number of preambles corresponding to the joint feature.

Some embodiments of the present disclosure provide an apparatus, which including: a processor; and a wireless transceiver coupled to the processor, wherein the processor is configured to: receive, with the wireless transceiver, multiple RACH configurations including a non-feature-related RACH configuration indicating a first subset of preambles in each RO of a set of ROs configured for a CB RA procedure, and at least one feature-related RACH configuration associated with a first number of features, wherein each feature-related RACH configuration indicates a subset of preambles in each RO of the set of ROs for a feature; and determine a set of preambles for the apparatus to perform an RA procedure in an RO based on the first subset of preambles and a second subset of preambles that are determined from the at least one feature-related RACH configurations for the first number of features.

Some other embodiments of the present disclosure provide an apparatus, which including: a processor; and a wireless transceiver coupled to the processor, wherein the processor is configured to: transmit, with the wireless transceiver, multiple RACH configurations including a non-feature-related RACH configuration indicating a first subset of preambles in each RO of a set of ROs configured for a CB RA procedure, and at least one feature-related RACH configuration associated with a first number of features, wherein each feature-related RACH configuration indicates a subset of preambles in each RO of the set of ROs for a feature; and determine a set of preambles for a UE to perform an RA procedure in an RO based on the first subset of preambles and a second subset of preambles that are determined from the at least one feature-related RACH configuration for the first number of features.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure;

FIG. 2 illustrates an exemplary method of preamble partitioning in an RO associated with one synchronization signal block (SSB) according to some embodiments of the present disclosure;

FIGS. 3A-3C illustrate some exemplary methods of determining preambles for performing a CB RA procedure by an advanced UE according to some embodiments of the present disclosure;

FIGS. 4A-4C illustrate some other exemplary methods of determining preambles for performing a CB RA procedure by an advanced UE according to some embodiments of the present disclosure;

FIGS. 5A and 5B illustrate some exemplary methods of determining preambles for a joint feature according to some embodiments of the present disclosure;

FIG. 6 illustrates a flow chart of an exemplary method performed by a UE according to some embodiments of the present disclosure; and

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that not all illustrated operations need be performed, for example, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3^{rd} generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a schematic diagram of an exemplary wireless communication system 100 according to some embodiments of the present disclosure.

As shown in FIG. 1, the wireless communication system 100 includes a base station, i.e., BS 102, and some UEs, i.e., UE 101-A, UE 101-B, and UE 101-C. UE 101-A, UE 101-B, and UE 101-C are within the coverage of BS 102. UE 101-A may be a normal UE, which is an old release UE before the target features being introduced into NR. Correspondingly, the normal UE cannot identify configurations for the UEs with any features. UE 101-B may be an advanced UE, which is a new release UE after the features are introduced into NR but has no feature. The advanced UE can identify configurations for UEs with any features. UE 101-C may be a feature UE, which is a new release UE with one or more features.

It is contemplated that, in accordance with some other embodiments of the present disclosure, a wireless communication system may include more BSs, and more or fewer UEs. Moreover, it is contemplated that names of UEs as illustrated and shown in FIG. 1 may be different.

In addition, although the UEs as shown in FIG. 1 are illustrated as particular types, it is contemplated that a communication system may include any type of UE in accordance with some other embodiments of the present disclosure. For example, the UEs may include industrial wireless sensors, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to an embodiment of the present disclosure, the UE 101-A, UE 101-B, or UE 101-C may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101-A, UE 101-B, or UE 101-C may include reduced capability wearable devices, such as smart watches, fitness bands, optical head-mounted displays, or the like. In some embodiments, the UE 101-A, UE 101-B, or UE 101-C may include reduced capability UEs such as wireless sensors and video surveillances. Moreover, the UE 101-A, UE 101-B, or UE 101-C may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101-A, UE 101-B, and UE 101-C may transmit uplink (UL) communication signals to the BS 102 and receive downlink (DL) communication signals from the BS 102.

UE 101-A, UE 101-B and UE 101-C in the embodiments of FIG. 1 may transmit information to BS 102 and receive control information from BS 102, for example, via NR Uu interface. BS 102 may define one or more cells, and each cell may have a coverage area.

BS 102 as illustrated and shown in FIG. 1 is not a specific base station, but may be any base station(s) in the communication system. For example, if the communication system includes two BSs 102, a UE being within a coverage area of any one of the two BSs 102 may be considered that the UE is within a coverage of BS 102 in the communication system; and only the UE being outside of coverage area(s) of both BSs 102 can be called as a case that the UE is outside of the coverage of BS 102 in the communication system.

The BS 102 may be distributed over a geographic region. In certain embodiments, the BS 102 may also be referred to as an access point, an access terminal, a base, a macro cell, a Node-B, an enhanced Node B (eNB), a gNB, a Home Node-B, a relay node, or a device, or described using other terminology used in the art. The BS 102 is generally part of a radio access network that may include one or more controllers communicably coupled to one or more corresponding BSs.

The wireless communication system 100 is compatible with any type of network that is capable of sending and receiving wireless communication signals. For example, the wireless communication system is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In an embodiment, the wireless communication system 100 is compatible with the 5G NR of the 3GPP protocol, wherein the BS 102 may transmit data using an orthogonal frequency division multiplexing (OFDM) modulation scheme on the DL and the UEs transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In other embodiments, the BS 102 may communicate using other communication protocols, such as the IEEE 802.11 family of wireless communication protocols. Further, in some embodiments, the BS 102 may communicate over licensed spectrums, whereas in other embodiments the BS 102 may communicate over unlicensed spectrums. The present disclosure is not intended to be limited to the implementation of any particular wireless communication system architecture or protocol. In another embodiment, the BS 102 may communicate with the UEs using the 3GPP 5G protocols.

In a 5G NR system, the RA procedure is utilized for various purposes. It may be utilized by a UE in initial access to find a cell to camp on, or may be utilized by a UE in a radio resource control (RRC) Idle or RRC Inactive state to switch to an RRC Connected state to start data transmission or reception, or may be utilized by an RRC Connected UE to re-establish UL synchronization when it is lost, etc.

A UE may start the RA procedure by transmitting a RACH preamble. In the case that the RACH preamble is chosen by the UE autonomously from a preamble set, the RA procedure is called as a contention-based (CB) RA procedure. In the case that the RACH preamble is designated by a BS, the RA procedure is called as a contention-free (CF) RA procedure.

In the CB RA procedure, multiple UEs share the same preamble set, and they “contend” the usage of the preambles in the preamble set. Therefore, two or more UEs might select the same preamble in the RA procedure and then a collision happens. There is a contention resolution procedure included in the CB RA procedure to resolve the collision.

In the CF RA procedure, the preamble is designated to each UE uniquely, and thus there is no collision issue.

After selecting the RACH preamble, the UE may transmit the RACH preamble in configured RA occasions (ROs). Each RO corresponds to a specific time-frequency resource in a RACH slot. Within each RACH slot, there may be one or more frequency domain ROs covering multiple consecutive resource blocks.

ROs are associated with synchronization signal blocks (SSBs) that may be transmitted with different spatial beams. The association between ROs and SSBs (or spatial beams) may be one-to-one, one-to-many, or many-to-one depending on the network configuration. The SSBs consist of DL synchronization signals and DL broadcasting signals for UEs to synchronize to DL, obtain a cell identity (ID), and acquire system information. A UE may measure the channel status of each SSB, select the SSB with the best channel quality, and transmit a RACH preamble in an RO that is associated with the selected SSB. This ensures that the RA procedure is performed in a beam with the best channel quality.

In each RO, there are 64 available preambles in total. A BS may divide these preambles into two parts. The first part includes a configured number of preambles and is used for RA procedure. The configured number may be represented by “totalNumberofRA-Preambles.” The preambles in the second part are reserved. The preambles in the first part may be further divided into one or more sets, and each set contains preambles for a SSB associated with the RO. As a result, for each SSB, there are “totalNumberofRA-Preambles #SSBs” available preambles in an RO for RA procedure, where #SSBs represents the number of SSB(s) which is (are) associated with the RO. The preambles for each SSB may be further divided into a contention-based (CB) preamble set and a contention-free (CF) preamble set, which are used for the CB RA procedure and the CF RA procedure, respectively. For a UE performing the CB RA procedure, it may choose a preamble from the CB preamble set. For a UE performing the CF RA procedure, the BS may designate a preamble for the UE from the CF preamble set.

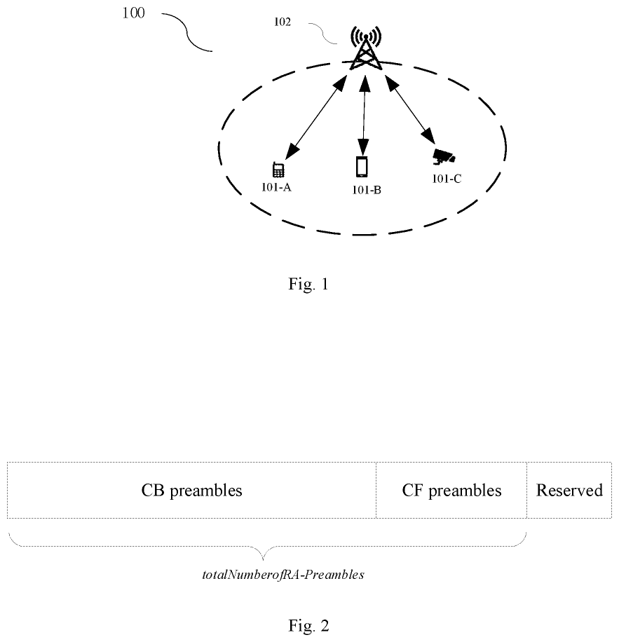

FIG. 2 illustrates an exemplary method of preamble partitioning in an RO associated with one SSB according to some embodiments of the present disclosure.

In FIG. 2, the preambles are divided into two parts: the first part includes “totalNumberofRA-Preambles” preambles for RA procedure; and the second part includes 64-“totalNumberofRA-Preambles” reserved preambles, which is marked as “Reserved” in FIG. 2.

The preambles in the first part are further divided into two sets. The first set is marked as “CB preambles,” which includes preambles from which a UE may choose one to perform the CB RA procedure in the RO. The number of preambles included in the first set may be represented as “CB-PreamblesPerSSB.” The second set is marked as “CF preambles,” which includes preambles from which a BS may designate one for a UE to perform the CF RA procedure in the RO. As shown in FIG. 2, the CB preambles are those with low indices, and the CF preambles follow the CB preambles (i.e., the CF preambles are those with higher indices than the CB preambles). The reserved preambles have the highest indices.

5G NR is gradually introducing features. For some features, a BS needs to identify UEs with these features during the initial access procedure or when the UEs switch from RRC Idle or RRC Inactive state to RRC Connected state, so that proper data scheduling could be performed for these UEs. According to some embodiments of the present disclosure, the features need to be identified may include but are not limited to the following features:
1. Reduced capability (RedCap). UEs with this feature may be referred to as RedCap UEs. Compared with normal UEs (i.e., UEs without this feature), RedCap UEs may have reduced bandwidth, reduced number of receiving antennas, etc. For example, UE 101-C in FIG. 1 may be a surveillance camera, which is a RedCap UE.
2. Small data transmission. UEs with this feature are UEs that perform small data transmission during the RA procedure.
3. Coverage enhancement (CE). UEs with this feature are UEs that are in bad coverage and need coverage recovery.
4. RAN slicing. UEs with this feature are UEs that are configured with a RA resource prioritization and slice isolation.

To identify a UE with a specific feature during the initial access procedure or when the UE switches from an RRC Idle or RRC Inactive state to an RRC Connected state, the BS may utilize RACH partitioning for the feature. RACH partitioning can be achieved by partitioning the ROs, that is, separate ROs are mapped to different features. Alternatively, RACH partitioning can be achieved by partitioning the preambles associated with an RO, that is, different preambles in the RO are mapped to different features.

In solutions utilizing partitioning of preambles, the CF preambles for the UEs without the features are divided into multiple parts, and one part is configured for one feature or one joint feature. Here one joint feature is associated with at least two independent features. For example, a joint feature “RedCap+CE” is associated with independent feature “RedCap” and independent feature “CE”, and a UE with this joint feature means that the UE is a RedCap UE which is in a bad coverage and needs coverage recovery.

However, dividing the CF preambles for the UEs without the features may cause some issues.

For example, if a cell supports one or more features and joint features, all features share the same ROs with the UEs without the features, and each feature is configured with corresponding separate preambles, the CF preambles for the UEs without the features need to be extended to contain more preambles. The total number of the preambles is 64, which is fixed. That is, the increase of the total number of CF preambles renders the number of CB preambles decreasing correspondingly, which leads to a high preamble collision rate for the CB RA procedure for UEs without any features. Conversely, if the total number of the CB preambles for normal UEs is maintained, the RACH performance for the UEs with one or more features cannot be guaranteed with a limited number of preambles.

On the other hand, if separate ROs are configured for the UEs with the features, the RACH performance of the normal UEs without such features is not impacted. However, this will result in higher signaling overhead on RO configuration for each feature and also high resource (such as physical downlink control channel (PDCCH) or physical downlink shared channel (PDSCH) resources) overhead for the corresponding separate random access responses (RARs).

In conclusion, from reducing signaling overhead point of view, it is desired to share ROs configured for the UEs without the features as much as possible for the UEs with the features, while guaranteeing the RACH performance for the UEs without the features and for the UEs with features.

The present disclosure proposes some solutions to solve the above issues. Specifically, the present disclosure proposes that the advanced UEs could utilize different sets of CB preambles in different ROs for a specific RA procedure. The number of CB preambles in an RO for the advanced UEs is larger than or equal to the number of CB preambles for normal UEs. Based on this, there are more available CB preambles for the advanced UEs to perform the CB RA procedure.

In some embodiments, in each RO of a specific set of ROs, the CB preambles available for the advanced UEs include two sets of preambles: the first set includes the CB preambles configured for normal UEs, and the second set includes the preambles configured for the features which are supported by a cell but are not configured in the RO.

In some other embodiments, in each RO of a specific set of ROs, the CB preambles available for the advanced UEs include two sets of preambles: the first set includes the CB preambles configured for normal UEs, and the second set of preambles is configured by the BS explicitly. In an embodiment, the second set of preambles are a subset of the CF preambles for normal UEs. In another embodiment, the second set of preambles are a subset of preambles for features which are supported by a cell but not configured in the RO.

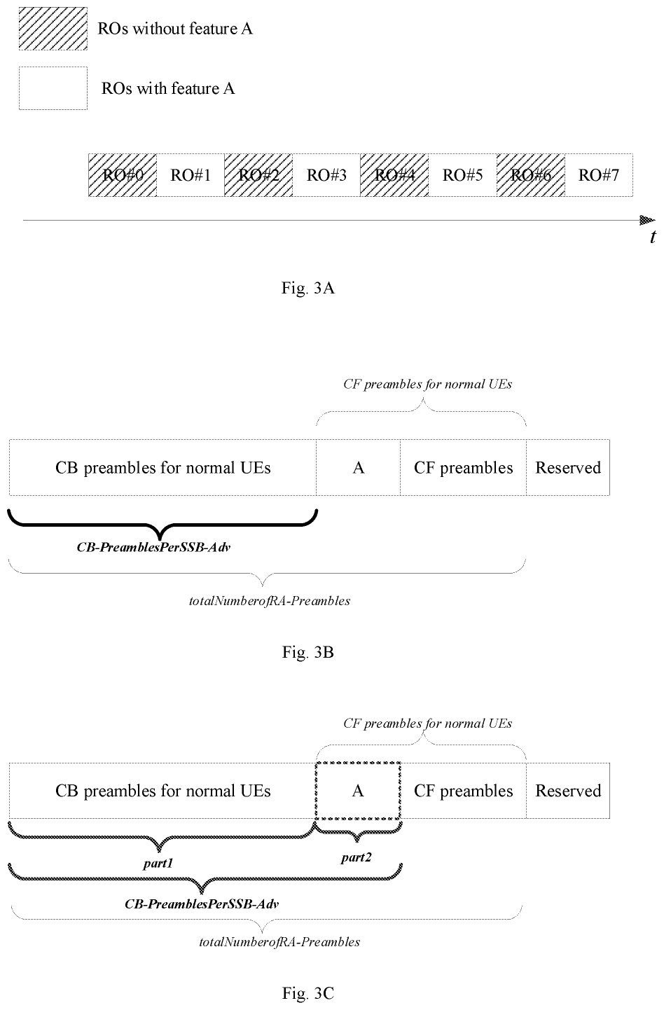

FIGS. 3A-3C illustrate some exemplary methods of determining preambles for performing a CB RA procedure by an advanced UE according to some embodiments of the present disclosure.

According to FIG. 3A, a set of ROs are numbered as RO #0, RO #1, RO #2, . . . , RO #7. The ROs with odd indices, i.e., RO #1, RO #3, RO #5, and RO #7, are configured with feature A. A feature-related RACH configuration associated with feature A may indicate ROs configured with feature A and/or a number of preambles configured for feature A. In other words, UEs with feature A may use the preambles configured for feature A to perform the CB RA procedure in these ROs. The ROs with even indices, i.e., RO #0, RO #2, RO #4, and RO #6, are configured without feature A. That is, UEs with feature A cannot perform the CB RA procedure in these ROs.

FIG. 3B depicts partitioning of the preambles in an RO with feature A (e.g., RO #1, RO #3, RO #5, or RO #7), and FIG. 3C depicts partitioning of the preambles in an RO without feature A (e.g. RO #0, RO #2, RO #4, and RO #6).

In FIGS. 3B and 3C, the total preambles are divided into two parts: the first part includes the preambles for RA procedure, and the number of the preambles in the first part is “totalNumberOfRA-preambles,” which may be configured via a non-feature-related RACH configuration; and the second part includes the reserved preambles, which are marked as “Reserved.” The preambles for RA procedure are further divided into two sets: the first set is the preamble set configured for normal UEs to perform the CB RA procedure, which is marked as “CB preambles for normal UEs”; and the second set is marked as “(F preambles for normal (Es.” The normal UEs may deem the preambles in the second set as preambles configured for them to perform the CF RA procedure because the normal UEs cannot identify further preamble portioning in this set. Advanced UEs may identify that the “(′F preambles for normal UEs” are further divided into two subsets: the first subset includes preambles configured for feature A, which is marked as “A” in the figure; and the second subset is marked by “CF preambles,” from which the BS may designate one for a UE to perform the CF RA procedure.

For normal UEs, the CB preambles are the same in all the configured ROs, i.e. RO #0, RO #1, RO #2, . . . , RO #7. Specifically, in both ROs shown in FIGS. 3B and 3C, the preambles for the normal UE to perform the CB RA procedure are the preambles marked as “CB preambles for normal UEs.” Therefore, in any RO, the normal UEs may use the preambles in the preamble set marked by “CB preambles for normal UEs” to perform the CB RA procedure.

For the UEs with feature A, they may perform the CB RA procedure in the ROs with feature A, that is, RO #1, RO #3, RO #5, and RO #7. In these ROs, for example, an RO as shown in FIG. 3B, the UEs with feature A may use the preambles in the preamble set marked by “A” to perform the CB RA procedure. However, in an RO as shown in FIG. 3C, which is not configured with feature A, the UEs with feature A cannot use the preambles in the preamble set marked by “A” to perform the CB RA procedure.

For the advanced UEs, in an RO as shown in FIG. 3B, which is configured with feature A, the advanced UEs may use the preambles in the preamble set marked by “CB preambles for normal UEs” to perform the CB RA procedure. That is, in such RO, the preambles for the advanced UEs to perform the CB RA procedure, as marked by “CB-PreamblesPerSSB-Adv,” are the same as “CB preambles for normal UEs”.

For the advanced UEs, in an RO as shown in FIG. 3C, which is configured without feature A, in addition to the preambles in the preamble set marked by “CB preambles for normal UEs,” the advanced UEs may also use the preambles in the preamble set marked by “A” to perform the CB RA procedure. That is, in such RO, the preambles for the advanced UEs to perform the CB RA procedure, as marked by “CB-PreamblesPerSSB-Adv,” include two parts: the first part, which is marked by “part1,” includes the preamble set marked by “CB preambles for normal UEs”; and the second part, which is marked by “part2,” includes the preamble set marked by “A.” The preamble set marked by “A” in FIG. 3C is corresponding to the preambles configured for feature A what is supported by the cell but not configured in the RO.

As can be seen, in the ROs without feature A, the number of the available preambles for the advanced UEs to perform the CB RA procedure is increased.

FIGS. 3A-3C illustrate the scenario with one feature. In other scenarios, there might be multiple features supported in the cell.

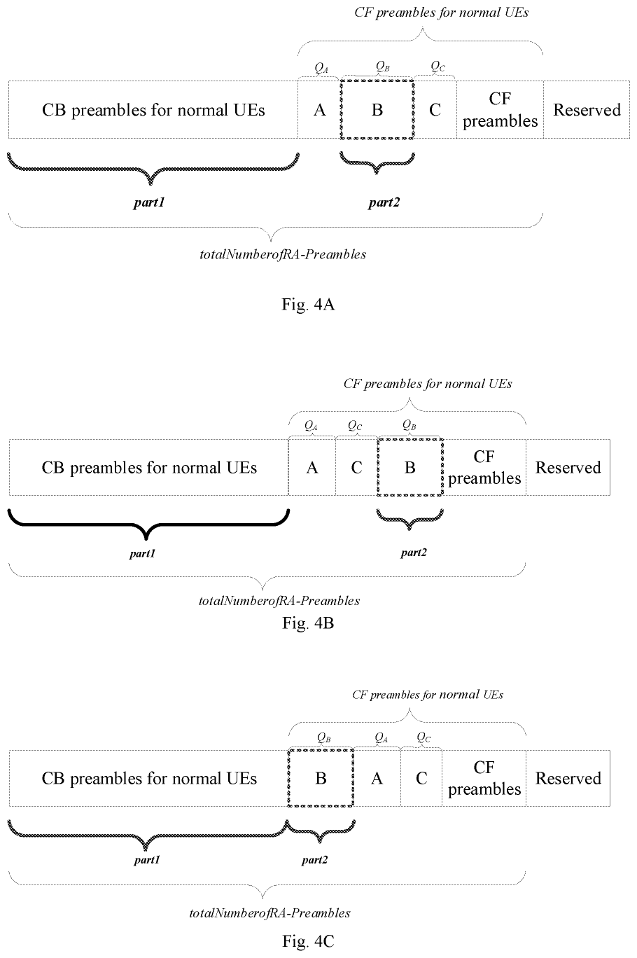

FIGS. 4A-4C illustrate some other exemplary methods of determining preambles for performing a CB RA procedure by an advanced UE according to some embodiments of the present disclosure. FIGS. 4A-4C use the same names of preamble sets as those used in FIGS. 3B and 3C, except that preambles for more than one feature are configured.

In the examples shown in FIGS. 4A-4C, three features, i.e., feature A, feature B, and feature C are configured or deployed in a cell. The BS may configure an order for each of features A, B, and C, e.g., via feature-related RACH configurations in system information block (SIB), each associated with one of features A, B, and C, or the configuration is carried outside of feature-related RACH configurations in SIB. For example, the first one is A, the second one is B, and the third one is C. The BS may also configure the numbers of the CB preambles for features A, B, and C as QA, Q_{B}, and Q_{C}, respectively, via the feature-related RACH configurations. Based on the order of each feature and the number of preambles for each feature, the advanced UEs and UEs with the features could determine the preamble subsets for each feature correspondingly. The preamble subsets marked by “A,” “B,” and “C” are determined for features A, B, and C, respectively. In the RO as shown in FIGS. 4A-4C, feature A and feature C are configured, while feature B is not. The preamble set marked by “B” in FIG. 4A-4C is corresponding to the preambles configured for feature B what is supported by the cell but not configured in the RO. Accordingly, in this RO, UEs with feature A may use the preambles in the preamble subset marked by “A” to perform the CB RA procedure, and UEs with feature C may use the preambles in the preamble subset marked by “C” to perform the CB RA procedure, while UEs with feature B cannot use the preambles in the preamble subset marked by “B” to perform the CB RA procedure because feature B is not configured in this RO. Instead, advanced UEs may use the preambles in the CB preamble set for normal UEs (marked as “part1”) and the preamble subset marked by “B” (marked as “part2”) to perform the CB RA procedure in the RO.

In some embodiments of the present disclosure, it is assumed that there are M features supported by the cell, wherein N features are configured in the RO, and M-N features are not configured in the RO. There are several options for determining the preambles corresponding to the M features.
Option 1: the preambles corresponding to the M features are determined based on the orders of the M features correspondingly. The preambles for the M features start right after the CB preambles for normal UEs. For example, as shown in FIG. 4A, the preambles for feature A, feature B, and feature C are determined in the RO, and feature B is not configured in the RO. The three features are ordered as {A, B, C}. Therefore, the order of the preambles corresponding to features A, B, and C is: the first is the preambles corresponding to feature A, the second is the preambles corresponding to feature B, and the third is the preambles corresponding to feature C. The preambles for feature B are taken as the CB preambles for the advanced UEs.
Option 2: the preambles for each of the configured N features in the RO are determined based on the relative order of the N features in the M features. The preambles for the N features start right after the CB preambles for normal UEs. The preambles for M-N non-configured features are also determined based on the relative order of the M-N features in the M features, and start after the preambles for the N features. The preambles for the M-N features are taken as CB preambles for the advanced UEs. For example, as shown in FIG. 4B, the three features are ordered as {A, B, C}, and then the preambles for the features A, B, and C are ordered as {preambles corresponding to feature A, preambles corresponding to feature C, preambles corresponding to feature B}.
Option 3: the preambles for each of the configured N features in the RO are determined based on the relative order of the N features in the M features. The preambles for the M-N non-configured features are also determined based on the relative order of the M-N features in the M features, and start right after the CB preambles for normal UEs, and are taken as CB preambles for the advanced UEs. The preambles for the N features start after the preambles for the M-N features. For example, as shown in FIG. 4C, the three features are ordered as {A, B, C}, and then the preambles for the features A, B, and C are ordered as {preambles corresponding to feature B, preambles corresponding to feature A, preambles corresponding to feature C}.

Based on the order of each feature and the number of preambles for each feature, the advanced UEs and UEs with the features could determine the preamble subsets for each feature correspondingly. The CB preambles for the feature with the lowest order starts from the first preamble after CB preambles for the normal UEs, followed by CB preambles for the feature with the second lowest order, and so on.

For example, in FIG. 4A, if the index of the first preamble is 0, and the total number of the CB preambles for normal UEs is CB-PreamblePerSSB, then the preambles for feature A contain preambles with indices from CB-PreamblePerSSB to CB-PreamblePerSSB+Q_{A}−1; the preambles for feature B contain preambles with indices from CB-PreamblePerSSB+Q_{A}, to CB-PreamblePerSSB+Q_{A}+Q_{B}−1, and so on.

In FIG. 4B, the preambles for feature A contain preambles with indices from CB-PreamblePerSSB to CB-PreamblePerSSB+Q_{A}−1; the preambles for feature C contain preambles with indices from CB-PreamblePerSSB+Q_{A} to CB-PreamblePerSSB+Q_{A}+Q_{C}−1; and the preambles for feature B contain preambles with indices from CB-PreamblePerSSB+Q_{A}+Q_{C} to CB-PreamblePerSSB+Q_{A}+Q_{C}+Q_{B}−1.

In FIG. 4C, the preambles for feature A contain preambles with indices from CB-PreamblePerSSB+Q_{B} to CB-PreamblePerSSB+Q_{B}+Q_{A}−1; the preambles for feature C contain preambles with indices from CB-PreamblePerSSB+Q_{B}+Q_{A}, CB-PreamblePerSSB+Q_{B}+Q_{A}+Q_{C}−1; and the preambles for feature B contain preambles with indices from CB-PreamblePerSSB to CB-PreamblePerSSB+Q_{B}−1.

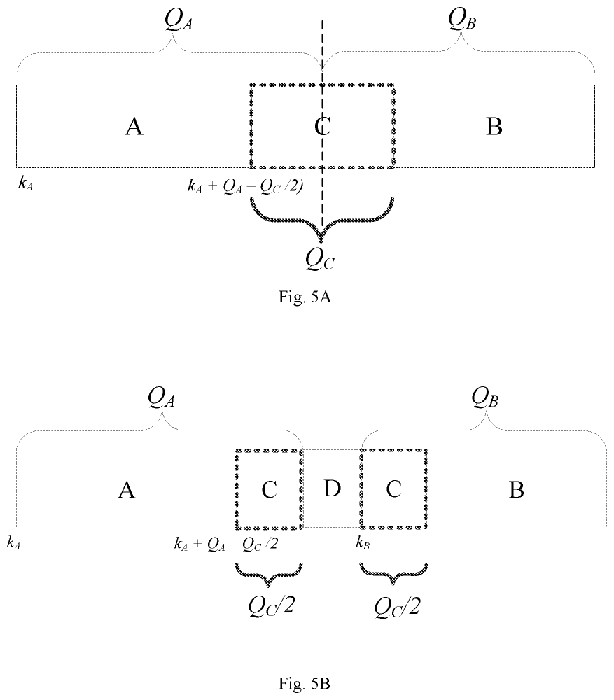

FIGS. 5A and 5B illustrate some exemplary methods of determining preambles for a joint feature according to some embodiments of the present disclosure.

In FIG. 5A, there is a joint feature C, which is a combination of independent feature A and independent feature B. For example, the independent feature A may be RedCap, and the independent feature B may be coverage enhancement (CE). Then the joint feature C is “RedCap+CE,” which means that a RedCap UE is in a bad coverage and needs coverage recovery.

For a joint feature, the preambles are determined implicitly. The BS configures the number of preambles for the joint feature and the numbers of preambles for the independent features that the joint feature relates with. In an embodiment, the preambles for each of the independent features is determined at first, then the preambles for the joint feature is determined accordingly based on the preambles for the independent features. In an embodiment, the first half of preambles of the joint feature come from one related independent feature with the lower order, and the second half of the joint feature come from the other related independent feature with the higher order. In an embodiment, the first half of the preambles of the joint feature come from the last part of the preambles of one related independent feature with lower order and the second half of the preambles of the joint feature come from the first part of the preambles of the other related independent feature.

For example, in FIG. 5A, the BS configures the number of preambles for feature C to be Q_{C}, and the preambles for feature C are associated with the preambles corresponding to independent feature A and independent feature B. Independent feature A has the lower order, and independent feature B has the higher order. The numbers of preambles for independent feature A and independent feature B are Q_{A} and Q_{B}, respectively, the preambles for independent feature A starts from preamble index k_{A}, the preambles for independent feature B are next to the preambles for independent feature A, and then the index of the first preamble for the joint feature C is: K_{A}+Q_{A}−Q_{C}/2.

In FIG. 5B, the independent feature A and independent feature B are not located next to each other. The preambles for independent feature A starts from preamble index k_{A}. In this case, the preambles for the joint feature C include two halves. The first half of preambles of the joint feature C come from the preambles for independent feature A, and the index of the first preamble of the first half of preambles is: K_{A}+Q_{A} Q_{C}/2. The second half of preambles of the joint feature C come from the preambles for independent feature B, and the index of the first preamble of the second half of preambles is: k_{B}.

Alternatively, the index of the first preamble for the joint feature is indicated explicitly. For example, in FIG. 5A, the BS may indicate that the index of the first preamble for feature Cis: K_{A}+Q_{A} Q_{C}/2.

In some embodiment, in the case that the BS does not configure the preambles for a joint feature, the preambles for such a joint feature will use those configured for a related independent feature that has a lower order or a higher order according to a predefined rule. For example, when the BS does not configure any preambles for joint feature C related with independent feature A and independent feature B, and independent feature A has a higher order than independent feature B, the UEs with feature C may use the preambles for independent feature A to perform the CB RA procedure.

In some other embodiments, the preambles for a non-configured feature in an RO could be indicated to be used by a configured feature in the RO. For example, in FIG. 4A, the preambles for feature B may be indicated to be used by the UEs with feature A.

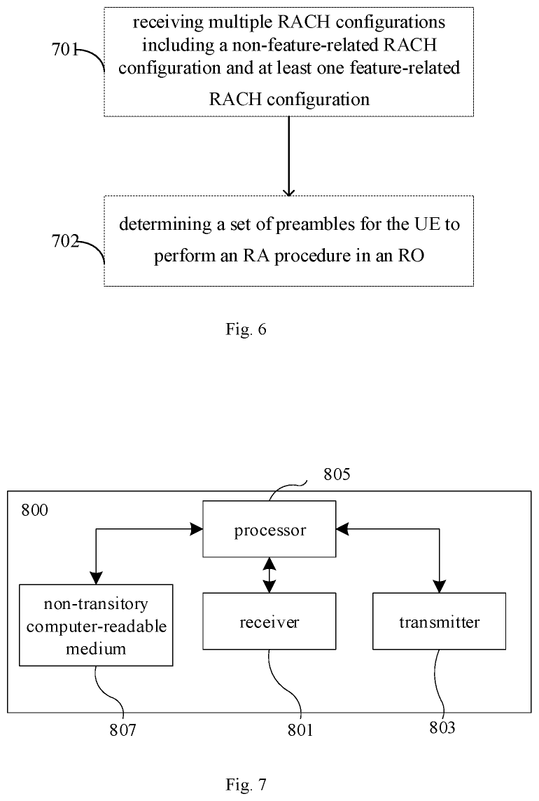

FIG. 6 illustrates a flow chart of an exemplary method performed by a UE according to some embodiments of the present disclosure.

In step 701, the UE receives multiple RACH configurations from a BS. Correspondingly, at the BS side, the BS transmits the multiple RACH configurations to the UE. The multiple RACH configurations include a non-feature-related RACH configuration, which indicates a first subset of preambles in each RO of a set of ROs configured for a CB RA procedure, e.g., the preambles marked as “CB preambles for normal UEs” in FIG. 4A. The multiple RACH configurations also include at least one feature-related RACH configuration associated with a first number of features, wherein each feature-related RACH configuration indicates a subset of preambles in each RO of the set of ROs for a feature. For instance, the multiple RACH configurations include three feature-related RACH configurations associated with feature A, feature B, and feature C, respectively, as shown in FIG. 4A. The feature-related RACH configuration for feature A indicates a subset of preambles in each RO of the set of ROs marked as “A” in FIG. 4A, the feature-related RACH configuration for feature B indicates a subset of preambles in each RO of the set of ROs marked as “B” in FIG. 4A, and the feature-related RACH configuration for feature C indicates a subset of preambles in each RO of the set of ROs marked as “C” in FIG. 4A.

In step 702, the UE determines a set of preambles for the UE to perform an RA procedure in an RO based on the first subset of preambles and a second subset of preambles that are determined from the at least one feature-related RACH configuration for the first number of features. For example, the UE may use the preambles marked as “CB preambles for normal UEs” and the preambles marked as “B” in the RO shown in FIG. 4A.

In some embodiments, the first number of features include at least one of: reduced capability, coverage enhancement, small data transmission, and RAN slicing. For instance, the feature A may be reduced capability, and feature B may be coverage enhancement, etc.

The set of preambles for the UE may include the first subset of preambles and the second subset of preambles. The first subset may be the preambles marked as “CB preambles for normal UEs” in FIG. 4A. The second subset may include the preambles configured by the BS. In some other cases, the second subset of preambles includes the preambles that are configured for each of a second number of features among the first number of features that are not associated with the RO. Take FIG. 4A as an example, the first number of features include feature A, feature B, and feature C, the second number of features include feature B, which is not associated with the RO in FIG. 4A. The second subset of preambles includes the preambles configured for feature B.

The order of each feature in the first number of features is preconfigured or indicated by the at least one feature-related RACH configuration, based on which the preambles for each feature are determined.

In some embodiments, the preambles for each of a third number of features among the first number of features that are associated with the RO include a number of first sub-subsets, each first sub-subset corresponds to a feature in the third number of features, the preambles that are configured for each of the second number of features include a number of second sub-subsets, each second sub-subset corresponds to a feature in the second number of features, an order of each first sub-subset in the number of first sub-subsets is determined according to the relative order of feature(s) corresponding to the number of first sub-subsets, and an order of each second sub-subset in the number of second sub-subsets is determined according to the relative order of feature(s) corresponding to the number of second sub-subsets. For example, in FIG. 4B, the third number of features among the first number of features that are associated with the RO include feature A and feature C, both feature A and feature C correspond to a first sub-subset of preambles respectively (preambles marked by “A” and “C”). The second number of features among the first number of features that are not associated with the RO include feature B, and feature B corresponds to a second sub-subset (preambles marked by “B”). The order of each preamble sub-subset “A” and preamble sub-subset “C” are determined based on the relative order of the feature A and feature C.

In some embodiments, an order of each sub-subset in the number of first sub-subsets and the number of second sub-subsets is determined according to the order of a feature corresponding to the sub-subset. For example, in FIG. 4A, the order of each sub-subset in preamble sub-subset “A,” preamble sub-subset “B,” and preamble sub-subset “C” is determined according to the order of each of feature A, feature B, and feature C.

In some embodiments, each first sub-subset has an order lower than that of any second sub-subset. For example, in FIG. 4B, preamble sub-subset “A” and preamble sub-subset “C” have an order lower than preamble sub-subset “B.”

In some other embodiments, each second sub-subset has an order lower than that of any first sub-subset. For example, in FIG. 4C, preamble sub-subset “A” and preamble sub-subset “C” have an order higher than preamble sub-subset “B.”

According to some embodiments, the first number of features may include a joint feature relating to at least a first independent feature and a second independent feature, and the at least one feature-related RACH configuration indicates at least a second number of preambles corresponding to the first independent feature and a third number of preambles corresponding to the second independent feature. As shown in FIG. 5A, the joint feature C relates to independent feature A and independent feature B, the total number of preambles for feature A is Q_{A}, and the total number of preambles for feature B is Q_{B}.

In some embodiments, the at least one feature-related RACH configuration further indicates a fourth number of preambles corresponding to the joint feature, and the joint feature is configured with the third number of preambles including at least a first part of preambles from the first number of preambles and a second part of preambles from the second number of preambles. For example, in FIG. 5A, the BS may transmit a feature-related RACH configuration indicating that the total number of preambles for joint feature C is Q_{c}, and the preambles for joint feature C include a part of preambles coming from preambles corresponding to independent feature A and another part of preambles coming from preambles corresponding to independent feature B.

In some other embodiments, the first number of preambles or the second number of preambles are configured for the joint feature when no RACH configuration indicates a number of preambles corresponding to the joint feature. That is, the BS may not transmit a feature-related RACH configuration indicating that the total number of preambles for joint feature C. In this case, the UEs with feature C may use preambles for feature A or feature B according to a predefined rule or configuration.

FIG. 7 illustrates a simplified block diagram of an exemplary apparatus 800 according to some embodiments of the present application. The apparatus 800 may be or include at least a part of a UE (e.g., the UE 101-A, UE 101-B, or UE 101-C as illustrated in FIG. 1) or other device with similar functionality.

As shown in FIG. 7, the apparatus 800 may include a receiver 801, a transmitter 803, a processer 805, and a non-transitory computer-readable medium 807. The non-transitory computer-readable medium 807 has computer executable instructions stored therein. The processer 805 is configured to be coupled with the non-transitory computer readable medium 807, the receiver 801, and the transmitter 803. It can be contemplated that, in some other embodiments of the present application, the apparatus 800 may include more computer-readable mediums, receivers, transmitters and processors according to practical requirements. In some embodiments of the present application, the receiver 801 and the transmitter 803 can be a wireless receiver and a wireless transmitter, respectively, and can be integrated into a single device, such as a wireless transceiver. In certain embodiments, the apparatus 800 may further include an input device, a memory, and/or other components.

In some embodiments of the present application, the non-transitory computer-readable medium 807 may have stored thereon computer-executable instructions to cause the processor 805 to implement the method performed by the UE according to any embodiment of the present application, e.g., the method illustrated in FIG. 6.

For example, the processor 805 may be configured to receive, via the receiver 801, multiple RACH configurations. The processor 805 may be further configured to determine a set of preambles for the UE to perform a RA procedure in an RO.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a user equipment (UE), the method comprising:
receiving, from a base station (BS), multiple random access (RA) channel (RACH) configurations comprising a non-feature-related RACH configuration indicating a first subset of preambles in each RA occasion (RO) of a set of ROs configured for a contention-based (CB) RA procedure, and at least one feature-related RACH configuration associated with a first number of features, each feature-related RACH configuration indicating a subset of preambles in each RO of the set of ROs for a feature; and
determining a set of preambles to perform an RA procedure in an RO based on the first subset of preambles and a second subset of preambles that are determined from the at least one feature-related RACH configuration for the first number of features.

2. The method of claim 1, wherein the first number of features comprise at least one of: reduced capability, coverage enhancement, small data transmission, and radio access network (RAN) slicing.

3. (canceled)

4. (canceled)

5. The method of claim 1, wherein an order of each feature in the first number of features is preconfigured or indicated by a configuration in system information block, based on which the preambles for the features are determined.

6-12. (canceled)

13. A base station (BS) for wireless communication, comprising:
at least one memory; and
at least one processor coupled with the at least one memory and configured to cause the base station to:
transmit, to a user equipment (UE), multiple random access (RA) channel (RACH) configurations comprising a non-feature-related RACH configuration indicating a first subset of preambles in each RA occasion (RO) of a set of ROs configured for a contention-based (CB) RA procedure, and at least one feature-related RACH configuration associated with a first number of features, each feature-related RACH configuration indicating a subset of preambles in each RO of the set of ROs for a feature; and
determine a set of preambles to perform an RA procedure in an RO based on the first subset of preambles and a second subset of preambles that are determined from the at least one feature-related RACH configuration for the first number of features.

14. The BS of claim 13, wherein the first number of features comprise at least one of: reduced capability, coverage enhancement, small data transmission, and radio access network (RAN) slicing.

15. A user equipment (UE) for wireless communication, comprising:
at least one memory; and
at least one processor coupled with the at least one memory and configured to cause the UE to:
receive multiple random access (RA) channel (RACH) configurations comprising a non-feature-related RACH configuration indicating a first subset of preambles in each RA occasion (RO) of a set of ROs configured for a contention-based (CB) RA procedure, and at least one feature-related RACH configuration associated with a first number of features, each feature-related RACH configuration indicating a subset of preambles in each RO of the set of ROs for a feature; and
determine a set of preambles to perform an RA procedure in an RO based on the first subset of preambles and a second subset of preambles that are determined from the at least one feature-related RACH configuration for the first number of features.

16. The UE of claim 15, wherein the first number of features comprise at least one of: reduced capability, coverage enhancement, small data transmission, and radio access network (RAN) slicing.

17. The UE of claim 15, wherein the set of preambles comprises the first subset of preambles and the second subset of preambles, and wherein the second subset of preambles are configured by a base station (BS).

18. The UE of claim 15, wherein the set of preambles comprises the first subset of preambles and the second subset of preambles, and wherein the second subset of preambles comprises preambles that are configured for each of a second number of features among the first number of features that are not associated with the RO.

19. The UE of claim 15, wherein an order of each feature in the first number of features is preconfigured or indicated by a configuration in system information block, based on which the preambles for the features are determined.

20. The UE of claim 19, wherein preambles for each of a third number of features among the first number of features that are associated with the RO comprise a number of first sub-subsets, each first sub-subset corresponds to a feature in the third number of features, preambles that are configured for each of the second number of features comprise a number of second sub-subsets, each second sub-subset corresponds to a feature in the second number of features, an order of each first sub-subset in the number of first sub-subsets is determined according to a relative order of one or more features corresponding to the number of first sub-subsets, and an order of each second sub-subset in the number of second sub-subsets is determined according to a relative order of one or more features corresponding to the number of second sub-subsets.

21. The UE of claim 20, wherein an order of each sub-subset in the number of first sub-subsets and the number of second sub-subsets is determined according to the order of a feature corresponding to the sub-subset.

22. The UE of claim 20, wherein each first sub-subset has an order lower than that of any second sub-subset.

23. The UE of claim 20, wherein each second sub-subset has an order lower than that of any first sub-subset.

24. The UE of claim 15, wherein the first number of features comprise a joint feature relating to at least a first independent feature and a second independent feature, and the at least one feature-related RACH configuration indicates at least a first number of preambles corresponding to the first independent feature and a second number of preambles corresponding to the second independent feature.

25. The UE of claim 24, wherein the at least one feature-related RACH configuration further indicates a third number of preambles corresponding to the joint feature, and the joint feature is configured with the third number of preambles comprising at least a first part of preambles from the first number of preambles and a second part of preambles from the second number of preambles.

26. The UE of claim 24, wherein the first number of preambles or the second number of preambles are configured for the joint feature when no RACH configuration indicates a number of preambles corresponding to the joint feature.

27. A processor for wireless communication, comprising:
at least one controller coupled with at least one memory and configured to cause the processor to:
receive multiple random access (RA) channel (RACH) configurations comprising a non-feature-related RACH configuration indicating a first subset of preambles in each RA occasion (RO) of a set of ROs configured for a contention-based (CB) RA procedure, and at least one feature-related RACH configuration associated with a first number of features, each feature-related RACH configuration indicating a subset of preambles in each RO of the set of ROs for a feature; and
determine a set of preambles to perform an RA procedure in an RO based on the first subset of preambles and a second subset of preambles that are determined from the at least one feature-related RACH configuration for the first number of features.

28. The processor of claim 27, wherein the first number of features comprise at least one of: reduced capability, coverage enhancement, small data transmission, and radio access network (RAN) slicing.

29. The processor of claim 27, wherein an order of each feature in the first number of features is preconfigured or indicated by a configuration in system information block, based on which the preambles for the features are determined.
